(19) United States
(12) Patent Application Publication
(10) Pub. No.: US 2025/0209654 A1
(43) Pub. Date: Jun. 26, 2025

(54) INFORMATION PROCESSING APPARATUS, INFORMATION PROCESSING METHOD, AND STORAGE MEDIUM

(71) Applicant: Tokyo Electron Limited, Tokyo (JP)

(72) Inventor: Daiki NAGAMATSU, Yamanashi (JP)

(21) Appl. No.: 18/985,733

(22) Filed: Dec. 18, 2024

(30) Foreign Application Priority Data
Dec. 20, 2023 (JP) 2023-214534

(51) Int. Cl. G06T 7/60; G06F 3/14; G06V 10/46

(52) U.S. Cl. CPC G06T 7/60; G06F 3/14; G06V 10/46; G06T 2207/10056

(57) ABSTRACT

An information processing apparatus processes a plurality of image data captured by an electron microscope. An information processing apparatus includes a binarization processing unit that binarizes a plurality of image data captured by an electron microscope into a measurement target area and an area other than the measurement target area; a measurement processing unit that measures dimension data of a plurality of measurement points in the measurement target area, using contour data of the measurement target area obtained from the image data binarized by the binarization processing unit; and an output processing unit that outputs an image visually illustrating a correlation between the dimension data of the plurality of measurement points and a plurality of parameters, using a process condition including the plurality of parameters in association with the image data.

### CROSS-REFERENCE TO RELATED APPLICATIONS

This application is based on and claims priority from Japanese Patent Application No. 2023-214534 filed on Dec. 20, 2023 with the Japan Patent Office, the disclosure of which is incorporated herein in its entirety by reference.

### TECHNICAL FIELD

The present disclosure relates to an information processing apparatus, a storage medium, and an information processing method.

### BACKGROUND

A method for calculating a dimensional measurement value from a contour line of a pattern extracted from an image captured by an electron microscope has been known in the art (see, e.g., Japanese Patent Application Laid-Open No. 2014-016361).

For example, dimension data of measurement points measured from the captured image has been manually indicated in a table or graphical format, and used for analysis.

### SUMMARY

An aspect of the present disclosure provides an information processing apparatus that processes a plurality of image data captured by an electron microscope. The information processing apparatus includes a binarization processing unit that binarizes the image data into a measurement target area and an area other than the measurement target area; a measurement processing unit that measures dimension data of a plurality of measurement points in the measurement target area, using contour data of the measurement target area obtained from the image data binarized by the binarization processing unit; and an output processing unit that outputs an image visually illustrating a correlation between the dimension data of the plurality of measurement points and a plurality of parameters, using a process condition including the plurality of parameters in association with the image data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of a substrate processing system according to an embodiment of the present disclosure.

FIG. 2 is a diagram illustrating a hardware configuration of a computer.

FIG. 3 is a configuration diagram illustrating functions of an information processing apparatus according to the present embodiment.

FIG. 4 is a flowchart of a processing performed by the information processing apparatus according to the present embodiment.

FIG. 5 is an image diagram of a measurement target image data.

FIG. 6 is an image diagram of a measurement target image data with reduced noise.

FIG. 7 is an image diagram of a measurement target image data.

FIG. 8 is a diagram illustrating an image histogram of a measurement target image data.

FIG. 9 is a diagram illustrating the relationship between the image histogram of the measurement target image data and a measurement target area.

FIG. 10 is an image diagram illustrating a measurement target image data and binarized measurement target image data.

FIG. 11 is an image diagram illustrating a plurality of measurement points in the binarized measurement target image data.

FIG. 12 is a graph diagram illustrating the correlation between dimension data of the plurality of measurement points and process parameters.

FIG. 13 is an image diagram of a mapping image illustrating the correlation between the dimension data of the plurality of measurement points in the measurement target image data and a plurality of process parameters, for each process parameter.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, embodiments of the present disclosure will be described with reference to the drawings. In the present embodiment, the correlation between film thickness dimensions and parameters included in process conditions (process parameters) is exemplified, but is not limited to the film thickness dimensions, and may be applied to pattern dimensions.

### <System Configuration>

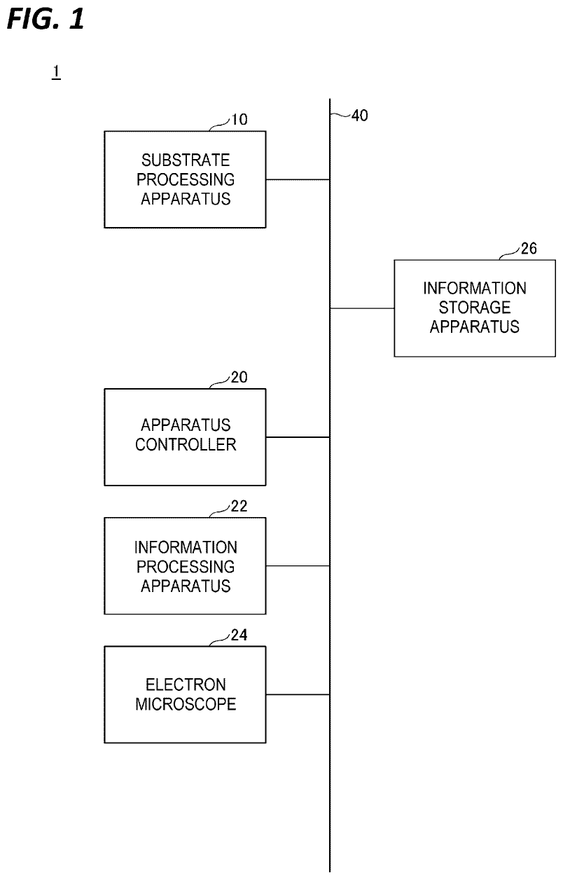

FIG. 1 is a configuration diagram of a substrate processing system 1 according to an embodiment of the present disclosure. The substrate processing system 1 illustrated in FIG. 1 includes a substrate processing apparatus 10, an apparatus controller 20, an information processing apparatus 22, an electron microscope 24, and an information storage apparatus 26.

The substrate processing apparatus 10, the apparatus controller 20, the information processing apparatus 22, the electron microscope 24, and the information storage apparatus 26 illustrated in FIG. 1 are communicatively connected via a network 40 such as the Internet or a local area network (LAN).

The substrate processing apparatus 10 is an apparatus that performs a processing such as a film formation processing, an etching processing, or an ashing processing, and processes a substrate such as a semiconductor wafer. The substrate processing apparatus 10 is, for example, a substrate processing apparatus 10, a heat treatment apparatus, or a film formation apparatus.

The substrate processing apparatus 10 receives, for example, control instructions (process parameters) according to a recipe, from the apparatus controller 20, and executes a process. The substrate processing apparatus 10 is equipped with a plurality of sensors such as a temperature sensor that measures a temperature and a pressure sensor that measures a pressure, so as to monitor a process state.

The apparatus controller 20 has a configuration of a computer for controlling the substrate processing apparatus 10. The apparatus controller 20 has a function of a man-machine interface that receives instructions for the substrate processing apparatus 10 from an operator and provides information regarding the substrate processing apparatus 10 to the operator. The apparatus controller 20 receives sensor values output from the plurality of sensors installed in the substrate processing apparatus 10.

The apparatus controller 20 may be installed in each substrate processing apparatus 10 or may be installed in each of a plurality of substrate processing apparatuses 10. The apparatus controller 20 may be installed within a case of the substrate processing apparatus 10.

The electron microscope 24 is an example of a device that images a processed result obtained by the substrate processing apparatus 10 performing a process according to process conditions and outputs image data. For example, the electron microscope 24 captures an image of an adhesion state of a film (film thickness) on a substrate processed by the substrate processing apparatus 10 according to process conditions as an example of the processed result, and outputs image data. The substrate is an example of an object which is captured.

The information storage apparatus 26 receives and stores a plurality of image data of an object captured by the electron microscope 24. The information storage apparatus 26 may store the process conditions when the substrate processing apparatus 10 processes the object that has been captured, in association with the image data of the object. The information storage apparatus 26 may receive sensor values output from the plurality of sensors installed in the substrate processing apparatus 10 and store them as a process log.

The information processing apparatus 22 is a computer that analyzes the plurality of image data of the object captured by the electron microscope 24. The information processing apparatus 22 has a function of a man-machine interface that receives instructions such as analysis from an operator and displays and provides an analyzed result to the operator.

The information processing apparatus 22 receives a measurement target image data from the electron microscope 24 or the information storage apparatus 26. The information processing apparatus 22 receives process conditions in association with the image data of the captured object from the information storage apparatus 26. The information processing apparatus 22 may associate the process conditions input by the operator with the measurement target image data received from the electron microscope 24 or the information storage apparatus 26. The measurement target image data or the process conditions may be input to the information processing apparatus 22 using a portable recording medium.

The information processing apparatus 22 processes the plurality of image data of the object captured by the electron microscope 24 as described below, thereby measuring measurement target dimension data for each measurement point, such as a film thickness on the substrate. The information processing apparatus 22 processes the data as described below, and outputs an image that visually illustrates the correlation between dimension data of a plurality of measurement points and process parameters included in the process conditions.

The substrate processing system 1 illustrated in FIG. 1 is provided by way of example, and examples of various system configurations may be provided depending on usage or purposes. The classification of apparatuses such as the apparatus controller 20, the information processing apparatus 22, the electron microscope 24, and the information storage apparatus 26 illustrated in FIG. 1 is provided by way of example. The substrate processing system 1 may have various configurations, such as a configuration in which at least two of the apparatus controller 20, the information processing apparatus 22, the electron microscope 24, and the information storage apparatus 26 are integrated or they are further separated.

### <Hardware Configuration>

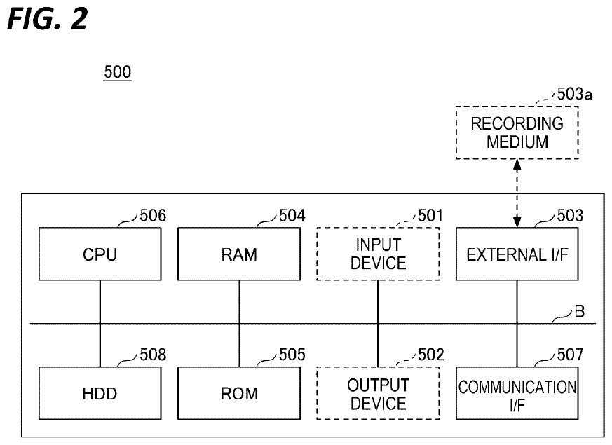

The apparatus controller 20, the information processing apparatus 22, and the information storage apparatus 26 of the substrate processing system 1 illustrated in FIG. 1 are implemented by a computer having a hardware configuration illustrated in FIG. 2, for example. FIG. 2 is a diagram illustrating a hardware configuration of a computer 500.

The computer 500 in FIG. 2 includes an input device 501, an output device 502, an external I/F (interface) 503, a random access memory (RAM) 504, a read only memory (ROM) 505, a central processing unit (CPU) 506, a communication I/F 507, and a hard disk drive (HDD) 508, each of which is connected by a bus B. The input device 501 and the output device 502 may be connected and used as needed.

The input device 501 is a keyboard, a mouse, or a touch panel, and is used by an operator to input an operation signal. The output device 502 is a display and displays a result of processing by the computer 500. The communication I/F 507 is an interface that connects the computer 500 to the network 40 illustrated in FIG. 1. The HDD 508 is an example of a non-volatile storage device that stores programs and data.

The external I/F 503 is an interface to an external device. The computer 500 may perform reading on a recording medium 503a such as a secure digital (SD) memory card via the external I/F 503. The external I/F 503 may perform recording on the recording medium 503a such as an SD memory card via the external I/F 503.

The ROM 505 is an example of a non-volatile semiconductor memory (storage device) in which programs and data are stored. The RAM 504 is an example of a volatile semiconductor memory (storage device) that temporarily holds programs and data. The CPU 506 is a computing device that reads programs and data from the storage device such as the ROM 505 or the HDD 508 and performs a processing to implement control or functions of the entire computer 500.

The apparatus controller 20, the information processing apparatus 22, and the information storage apparatus 26 of the substrate processing system 1 illustrated in FIG. 1 implement various functions by executing programs on the computer 500 illustrated in FIG. 2.

### <Functional Configuration>

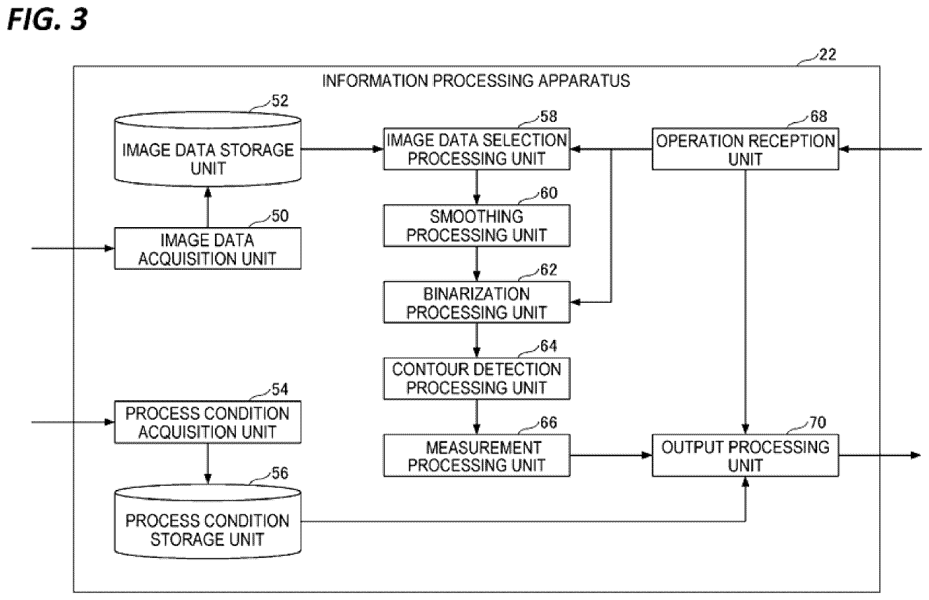

The information processing apparatus 22 of the substrate processing system 1 according to the present embodiment is implemented, for example, to have a functional configuration illustrated in FIG. 3. FIG. 3 is a configuration diagram illustrating functions of the information processing apparatus 22 according to the present embodiment. FIG. 3 does not illustrate functions that are unnecessary for explanation of the present embodiment.

The information processing apparatus 22 executes a program to implement an image data acquisition unit 50, an image data storage unit 52, a process condition acquisition unit 54, a process condition storage unit 56, an image data selection processing unit 58, a smoothing processing unit 60, a binarization processing unit 62, a contour detection processing unit 64, a measurement processing unit 66, an operation reception unit 68, and an output processing unit 70.

The image data acquisition unit 50 acquires the plurality of image data captured by the electron microscope 24. The image data storage unit 52 stores the plurality of image data acquired by the image data acquisition unit 50.

The process condition acquisition unit 54 acquires the process conditions when the substrate processing apparatus 10 has processed the object captured by the electron microscope 24. The process condition storage unit 56 stores the process conditions acquired by the process condition acquisition unit 54 in association with the plurality of image data stored in the image data storage unit 52.

The image data selection processing unit 58 selects measurement target image data from the image data stored in the image data storage unit 52. The image data selection processing unit 58 may select the measurement target image data from the image data stored in the image data storage unit 52 in accordance with a selective operation received by the operation reception unit 68 from the operator. The image data selection processing unit 58 may select the measurement target image data from the image data stored in the image data storage unit 52, in accordance with selection conditions received by the operation reception unit 68 from the operator (such as the designation of the substrate processing apparatus 10 that has processed the captured object).

The smoothing processing unit 60 reduces noise included in the measurement target image data selected by the image data selection processing unit 58. The binarization processing unit 62 determines a binarization threshold value as described below, based on an image histogram of the measurement target image data with reduced noise. In the image histogram, pixels included in the image data are indicated by a graph with a horizontal axis representing pixel values of the pixels and a vertical axis representing the number of pixel values. The binarization processing unit 62 may determine the binarization threshold value according to a setting operation received by the operation reception unit 68 from the operator. The binarization processing unit 62 may automatically determine the binarization threshold value, based on the image histogram of the measurement target image data. The binarization processing unit 62 binarizes the measurement target image data into a measurement target area (e.g., an area where a film is captured) and an area other than the measurement target area, using the determined binarization threshold value.

The contour detection processing unit 64 detects a boundary of the measurement target area, from the measurement target image data, which has been binarized (binarized measurement target image data). The contour detection processing unit 64 acquires contour data of the measurement target area by acquiring coordinates of pixels in the boundary.

The measurement processing unit 66 measures dimension data of a plurality of measurement points in the measurement target area, using the contour data of the measurement target area, which is obtained from the binarized measurement target image data. For example, the measurement processing unit 66 may measure actual dimensions of the measurement points from a distance (the number of pixels) between pieces of contour data of the measurement target area.

The operation reception unit 68 receives various operations from the operator and notifies a function corresponding to the operation received from the operator, of the content of the operation. The output processing unit 70 outputs an image (e.g., a mapping image described later) that visually illustrates the correlation between the dimension data of the plurality of measurement points and a plurality of process parameters, using process conditions including the plurality of process parameters in association with the measurement target image data.

### <Processing>

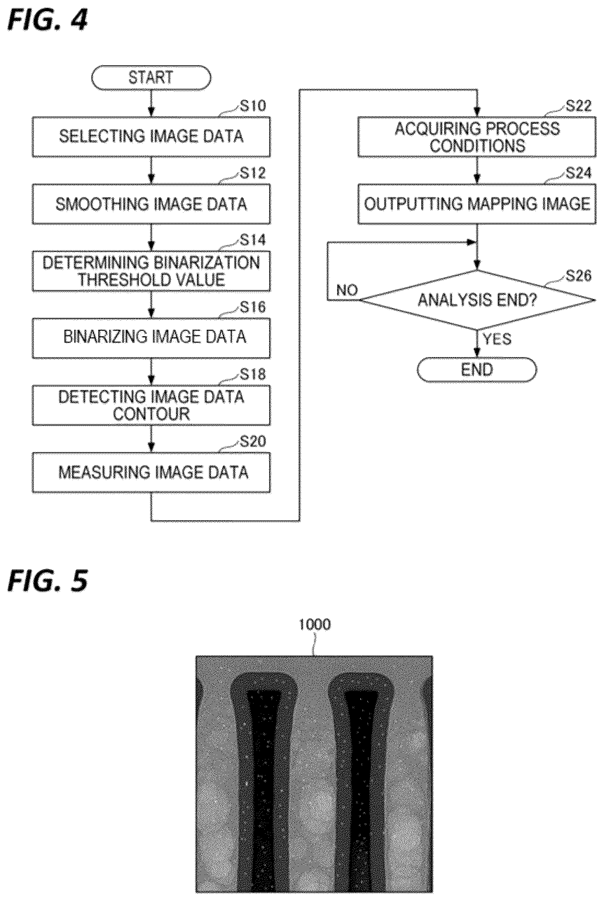

FIG. 4 is a flowchart of a processing by the information processing apparatus 22 according to the present embodiment.

In step S10, the image data selection processing unit 58 of the information processing apparatus 22 selects, for example, measurement target image data 1000 illustrated in FIG. 5, from the image data stored in the image data storage unit 52.

FIG. 5 is an image diagram of the measurement target image data 1000. The measurement target image data 1000 is a microscopic image (SEM image) of the film on the substrate processed by the substrate processing apparatus 10, which has been captured by the electron microscope 24.

In step S12, the smoothing processing unit 60 of the information processing apparatus 22 smoothes, for example, the measurement target image data 1000 illustrated in FIG. 5, and blurs the image, thereby reducing the effect of noise included in the measurement target image data 1000. The smoothing processing unit 60 may smooth the measurement target image data 1000 using a bilateral blur, which is an example of an edge-preserving smoothing filter. The bilateral blur is on a basis of a Gaussian filter.

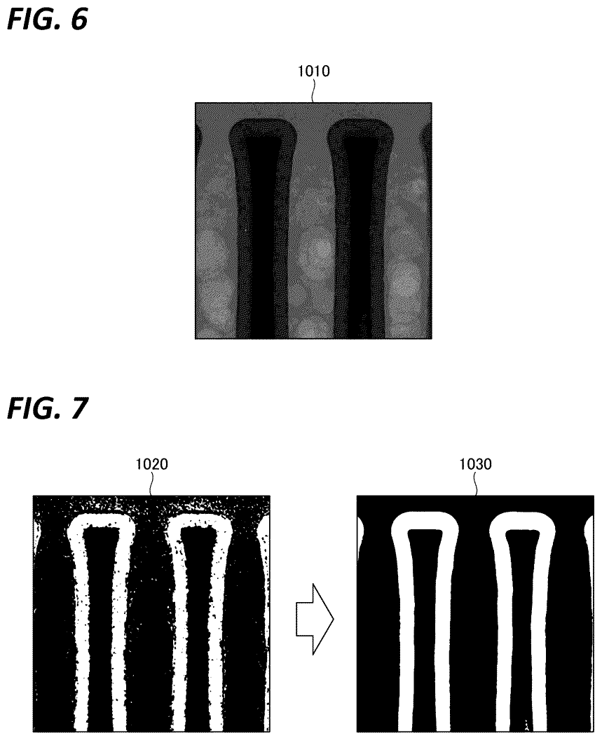

The smoothing processing unit 60 smoothes the measurement target image data 1000 illustrated in FIG. 5, and blurs the image, for example, like measurement target image data 1010 as illustrated in FIG. 6, while leaving (emphasizing) an edge portion therein. FIG. 6 is an image diagram of the measurement target image data 1010 with reduced noise.

The information processing apparatus 22 may perform a Gaussian fitting processing before a processing by the binarization processing unit 62. The Gaussian fitting processing is a processing for obtaining an approximation formula by performing fitting on the image histogram of the measurement target image data.

By performing the Gaussian fitting processing and determining a binarization threshold value from the obtained approximation formula before the processing by the binarization processing unit 62, the information processing apparatus 22 may obtain binarized measurement target image data 1030, for example, as illustrated in FIG. 7, in which a boundary of a measurement target area is clear, by the processing by the binarization processing unit 62.

FIG. 7 is an image diagram of measurement target image data 1020 and measurement target image data 1030. The measurement target image data 1020 is an example of binarized measurement target image data when the Gaussian fitting processing is not performed before the processing by the binarization processing unit 62. The measurement target image data 1030 is an example of binarized measurement target image data when the Gaussian fitting processing is performed before the processing by the binarization processing unit 62.

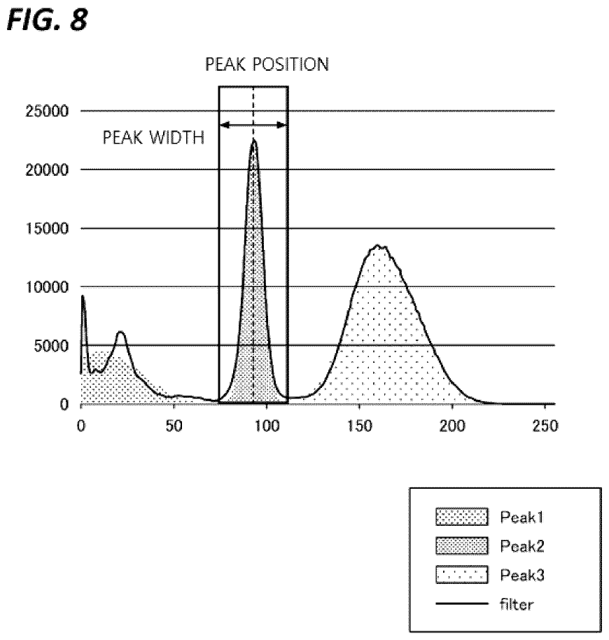

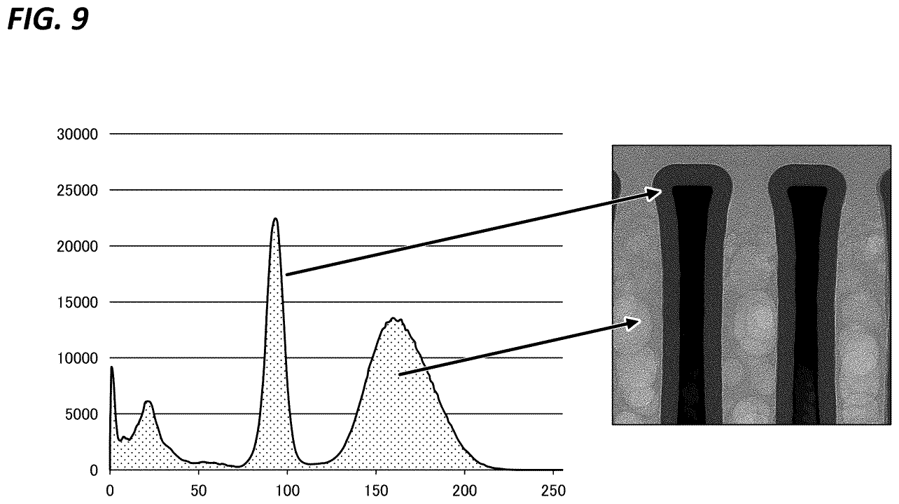

In step S14, the binarization processing unit 62 determines a binarization threshold value for detecting pixels having the color of the measurement target area, based on image histograms of measurement target image data, for example, as illustrated in FIGS. 8 and 9. FIG. 8 is a diagram illustrating an image histogram of the measurement target image data. FIG. 9 is a diagram illustrating the relationship between the image histogram of the measurement target image data and a measurement target area. The image histograms illustrated in FIGS. 8 and 9 indicate pixels included in the image data as graphs with a horizontal axis representing pixel values (black: 0 to white: 255) and a vertical axis representing the number of pixel values.

In the image histogram of the measurement target image data illustrated in FIG. 9, a peak position and a peak width in the highest center portion indicate a range of pixel values of pixels representing an area of a film in the measurement target image data. In addition, in the image histogram of the measurement target image data illustrated in FIG. 9, a peak position and a peak width in the second highest right portion indicate a range of pixel values of pixels close to white color other than the area of the film in the measurement target image data.

When the measurement target area is the area of the film, the binarization processing unit 62 determines a binarization threshold value for detecting pixels of the measurement target area in the measurement target image data, based on the peak position and the peak width in the highest center portion in the image histogram of FIG. 8. For example, the binarization processing unit 62 sets two pixel values at a position of the peak width (position corresponding to a valley between peaks) in the image histogram of FIG. 8 as a binarization threshold value.

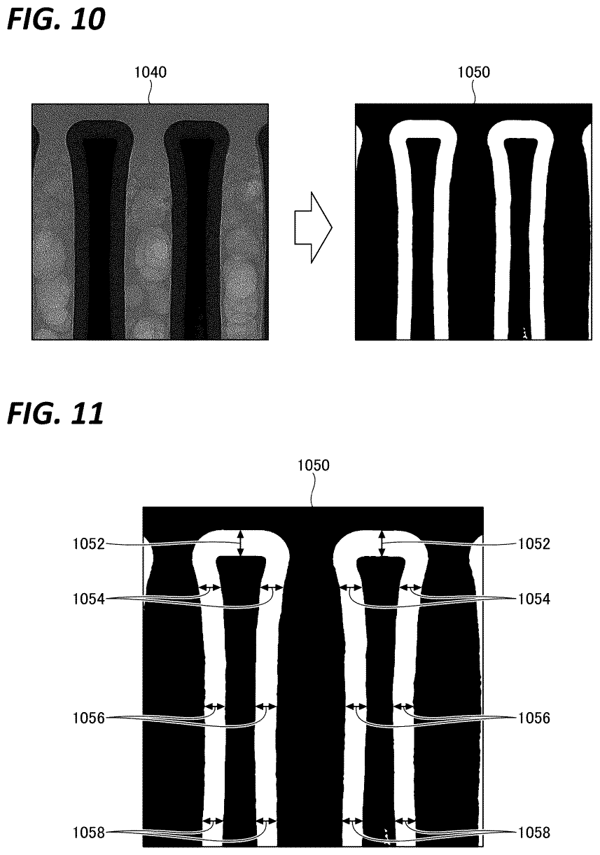

In step S16, the binarization processing unit 62 converts, for example, measurement target image data 1040 illustrated in FIG. 10, into two colors of white and black, like measurement target image data 1050 illustrated in FIG. 10, using the binarization threshold value determined in step S14. FIG. 10 is an image diagram of the measurement target image data 1040 and binarized measurement target image data 1050.

In the binarized measurement target image data 1050 illustrated in FIG. 10, a measurement target area (e.g., an area representing a film) is illustrated in white, and an area other than the measurement target area (e.g., an area other than the film) is illustrated in black. The binarization processing unit 62 binarizes the measurement target image data 1040 into a measurement target area and an area other than the measurement target area, as in the measurement target image data 1050, by converting the color of pixels detected by the binarization threshold value determined in step S14 and the color of pixels not detected by the binarization threshold value into a different color, white or black.

In step S18, the contour detection processing unit 64 detects the boundary of the measurement target area from the binarized measurement target image data 1050. The contour detection processing unit 64 acquires coordinates of pixels in the boundary and detects contour data of the measurement target area.

In step S20, the measurement processing unit 66 measures the dimension data of the plurality of measurement points in the measurement target area, using the contour data of the measurement target area detected in step S18, for example, as illustrated in FIG. 11. FIG. 11 is an image diagram illustrating a plurality of measurement points 1052 to 1058 of the binarized measurement target image data 1050. FIG. 11 illustrates, as an example of the plurality of measurement points, a measurement point 1052 in a top portion, measurement points 1054 in a top-side portion, measurement points 1056 in a middle-side portion, and measurement points 1058 in a bottom-side portion. The measurement points 1052 to 1058 in FIG. 11 are only provided by way of example, and measurement points may be disposed more finely.

The measurement processing unit 66 may measure actual dimensions of the measurement points 1052 to 1058 by using, for example, distances (the number of pixels) between pieces of contour data in areas of the measurement points 1052 to 1058 illustrated by arrows in FIG. 11 and a magnification at the time of imaging.

In step S22, the output processing unit 70 acquires process conditions in association with the binarized measurement target image data 1050 from the process condition storage unit 56. In step S24, the output processing unit 70 outputs a mapping image that visually illustrates the correlation between the dimension data of the plurality of measurement points 1052 to 1058 and a plurality of process parameters, using the plurality of process parameters included in the process conditions in association with the measurement target image data.

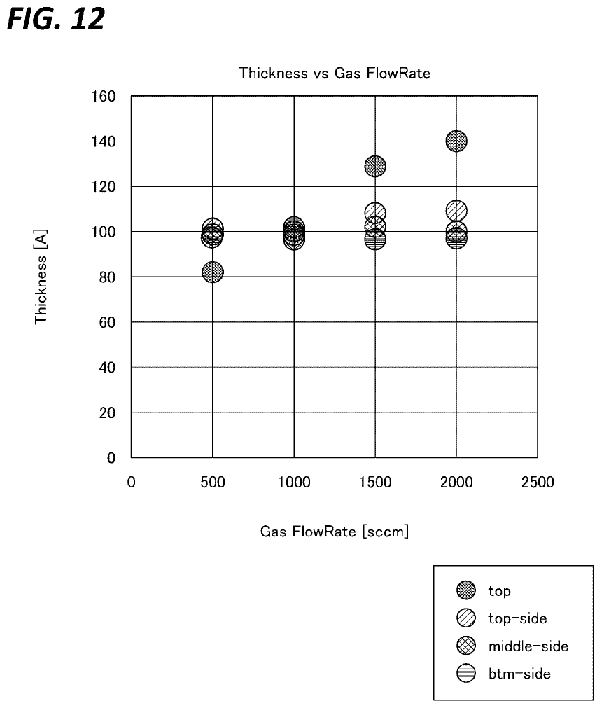

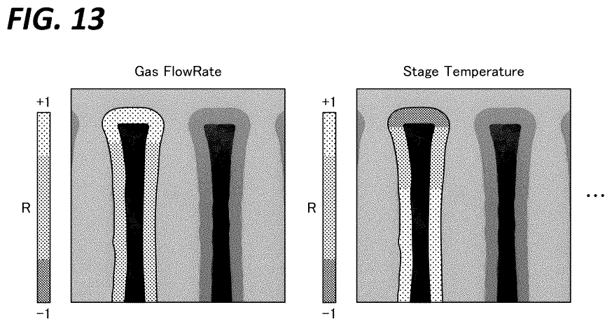

FIG. 12 is a graph illustrating the correlation between dimension data of the plurality of measurement points 1052 to 1058 and the process parameters. In the graph of FIG. 12, a horizontal axis represents a gas flow rate, which is an example of the process parameter, and a vertical axis represents the dimension data of the measurement points 1052 to 1058.

In FIG. 12, the dimension data of the plurality of measurement points 1052 to 1058 in the measurement target image data processed under process conditions in which process parameters of the gas flow rate are “500,” “1000,” “1500,” and “2000” is plotted. In FIG. 12, a correlation coefficient is calculated for each measurement point, by using the plot of the dimension data of the same measurement points with the process parameters of the gas flow rate having different values. For example, in FIG. 12, it may be confirmed that a change in the dimension data of the measurement point 1052 in the top portion is greater than changes in the dimension data of the measurement points 1054 to 1058 other than the top portion, so the process parameter of the gas flow rate is effective in the control of a film thickness at the measurement point 1052 in the top portion. In addition, in FIG. 12, the correlation coefficient between the gas flow rate, which is an example of the process parameter, and the dimension data of the plurality of measurement points 1052 to 1058 may be obtained from the plot of the dimension data of the measurement point 1052 in the top portion.

In step S24, the output processing unit 70 outputs a mapping image that visually illustrates the correlation between the dimension data of the plurality of measurement points in the measurement target image data 1000 and the plurality of process parameters, for each process parameter.

FIG. 13 is an image diagram of a mapping image that illustrates the correlation between the dimension data of the plurality of measurement points in the measurement target image data 1000 and the plurality of process parameters for each process parameter. The image diagram illustrated in FIG. 13 illustrates a mapping image of the gas flow rate and a mapping image of stage temperature, which are examples of process parameters.

The mapping image in FIG. 13 displays the correlation coefficient with the process parameter calculated for each dimension data of the plurality of measurement points, for example, as a change in color, in a superimposed manner on the plurality of measurement points in the measurement target image data 1000.

For example, referring to the mapping image for the gas flow rate in FIG. 13, the operator may recognize that the gas flow rate is effective in the control of a film thickness at the measurement point in the top portion, but is not quite effective in the control of a film thickness at measurement points other than that of the top portion. Also, referring to the mapping image for the stage temperature in FIG. 13, the operator may recognize that the stage temperature is effective in the control of a film thickness at the measurement points in the middle-side portion and the bottom-side portion, but is not quite effective in the control of a film thickness at the measurement points in the top portion and the top-side portion.

The mapping image illustrated in FIG. 13 may be output by selecting image data in association with process conditions for a center portion, and a plurality of image data with a change in the process parameters included in process conditions for the center portion, as measurement target image data, in the processing of step S10.

The mapping image in FIG. 13 is an example in which the measurement points are disposed more finer than the plurality of measurement points 1052 to 105 in the binarized measurement target image data 1050. By disposing the measurement points finely, the mapping image may also illustrate the correlation between the dimension data of the measurement points in the measurement target image data 1000 and the process parameters as color gradation.

The output of the mapping image in step S24 may display a list of a plurality of mapping images, or may display a mapping image of process parameters selected by the operator. The output of the mapping image in step S24 may also classify and display the mapping image. For example, the output of the mapping image in step S24 may classify and output the mapping image, such as a process parameter effective in the control of a film thickness at the measurement point in the top portion.

When the analysis of the mapping image by the operator is completed (YES in S26), the information processing apparatus 22 ends the processing of the flowchart in FIG. 4.

### SUMMARY

For example, when an operator intends to manually indicate, in a table or graphical format, dimension data of measurement points measured from an image captured by an electron microscope and to analyze the dimension data, the subjective evaluation of the operator may be involved in the analysis and may not be considered as an objective evaluation. Furthermore, in the manual analysis by the operator, since the amount of data may be enormous as the number of measurement points increases, it is difficult to increase the number of the measurement points due to limitation of time.

In the present embodiment, by using process conditions including a plurality of process parameters in association with measurement target image data, it is possible to automatically output an image that visually illustrates the correlation between dimension data of a plurality of measurement points and the plurality of process parameters.

Accordingly, according to the present embodiment, since an objective analysis result rather than a subjective analysis result may be obtained, the reliability of the analysis result is increased. Furthermore, according to the present embodiment, the processing of analysis that was previously performed manually by an operator may be automated, thereby achieving a significant reduction in time required for the analysis.

According to the present embodiment, an operator may more easily recognize process parameters that are effective or ineffective in the control of the dimension data of a plurality of measurement points, from an image that visually illustrates the correlation between the dimension data of the plurality of measurement points and the plurality of process parameters.

Thus, even for a complex pattern shape, the operator may easily find process parameters (knobs) that are effective or ineffective for the control of the shape.

With the substrate processing system 1 according to the present embodiment, it is possible to facilitate the recognition of the correlation between dimension data of measurement points measured from a plurality of image data and parameters of process conditions.

According to the present disclosure, it is possible to facilitate the recognition of the correlation between dimension data of measurement points measured from a plurality of image data and parameters of process conditions.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
binarization circuitry configured to binarize a plurality of image data captured by an electron microscope into a measurement target area and an area other than the measurement target area;
measurement circuitry configured to measure dimension data of a plurality of measurement points in the measurement target area, using contour data of the measurement target area obtained from the image data binarized by the binarization circuitry; and
output circuitry configured to output an image visually illustrating a correlation between the dimension data of the plurality of measurement points and a plurality of parameters, using a process condition including the plurality of parameters in association with the image data.

2. The information processing apparatus according to claim 1, wherein the output circuitry output the image visually illustrating the correlation between the dimension data of the plurality of measurement points and the plurality of parameters, for each parameter of the process condition.

3. The information processing apparatus according to claim 1, wherein the output circuitry display a correlation coefficient with the plurality of parameters calculated for each dimension data of the plurality of measurement points, in a superimposed manner on the plurality of measurement points in the image data.

4. The information processing apparatus according to claim 3, wherein the plurality of parameters in association with the image data are the plurality of parameters included in the process condition when a captured object is processed, and
the output circuitry calculate the correlation coefficient for each of the plurality of measurement points, using dimension data of the same measurement point in the plurality of image data in association with the parameters having different values.

5. The information processing apparatus according to claim 3, wherein the output circuitry display a color indicating the correlation coefficient with one of the parameters, in a superimposed manner on the plurality of measurement points in the image data.

6. A non-transitory computer-readable storage medium having stored therein a program that causes an information processing apparatus, to execute a process including:
binarizing a plurality of image data captured by an electron microscope into a measurement target area and an area other than the measurement target area;
measuring dimension data of a plurality of measurement points in the measurement target area, using contour data of the measurement target area obtained from the image data binarized in the binarizing; and
outputting an image visually illustrating a correlation between the dimension data of the plurality of measurement points and a plurality of parameters, using a process condition including the plurality of parameters in association with the image data.

7. An information processing method comprising:
providing an information processing apparatus for processing a plurality of image data captured by an electron microscope;
binarizing the image data into a measurement target area and an area other than the measurement target area;
measuring dimension data of a plurality of measurement points in the measurement target area, using contour data of the measurement target area obtained from the image data binarized in the binarizing; and
outputting an image visually illustrating a correlation between the dimension data of the plurality of measurement points and a plurality of parameters, using a process condition including the plurality of parameters in association with the image data.
